(19) United States
(12) Patent Application Publication
(10) Pub. No.: US 2026/0292089 A1
(43) Pub. Date: Sep. 24, 2026

(54) STORAGE MEDIUM, INFORMATION PROCESSING APPARATUS, AND METHOD FOR CONTROLLING INFORMATION PROCESSING APPARATUS FOR ACQUIRING IP ADDRESS ACCORDING TO OPERATING SYSTEM

(71) Applicant: CANON KABUSHIKI KAISHA, Tokyo (JP)

(72) Inventor: YOSHIRO MIHIRA, Tokyo (JP)

(21) Appl. No.: 19/572,494

(22) Filed: Mar. 19, 2026

(30) Foreign Application Priority Data
Mar. 21, 2025 (JP) 2025-046911

(51) Int. Cl. H04N 1/00

(52) U.S. Cl. CPC H04N 1/00938

(57) ABSTRACT

The present disclosure provides a non-transitory computer-readable storage medium storing a program that, when executed by a computer of an information processing apparatus, causes the computer to perform predetermined processing by the program for transmitting, to a communication apparatus, a scan job generated by the program, based on that the program is running on a host operating system (OS) of the information processing apparatus and is not running via a guest OS different from the host OS, and control the computer not to perform the predetermined processing, based on that the guest OS is running on the host OS and that the program is running on the guest OS.

### BACKGROUND

### Field of the Technology

The present disclosure relates to a storage medium, an information processing apparatus, and a method for controlling the information processing apparatus.

### Description of the Related Art

Japanese Patent Laid-Open No. 2009-049679 describes a configuration in which two virtual computers configured to run on an image processing apparatus operating system (image processing apparatus OS) (host operating system (host OS)) and a thin client operating system (thin client OS) (guest operating system (guest OS)) are stored in memory.

Meanwhile, as an operating environment on an operating system (OS) running as a host OS and which operates a guest OS has become widely adopted, there is a demand for improved usability programs that run in this operating environment.

### SUMMARY

The present disclosure is directed to improving the usability of a program that runs in an operating environment on an OS running as a host OS and which operates on a guest OS.

According to an aspect of the present disclosure, a non-transitory computer-readable storage medium storing a predetermined program configured to run on an operating system (OS), wherein the predetermined program causes a processor of a first information processing apparatus including a first operating environment on a first OS running as a host OS and not operational on a guest OS to perform a first acquisition process in the first information processing apparatus by causing the predetermined program to invoke a first application programming interface (first API) in a case where the predetermined program runs in the first operating environment, the first acquisition process being a process of acquiring an Internet Protocol (IP) address assigned to an interface associated with the first OS, and perform a first transmission process in the first information processing apparatus, the first transmission process including transmitting the IP address acquired by the first acquisition process and a scan job that causes a communication apparatus to perform a scan, and wherein the predetermined program causes a processor of a second information processing apparatus including a second operating environment on a second OS running as the host OS and operational on the guest OS to perform a second acquisition process in the second information processing apparatus by causing the predetermined program to invoke a second API different from the first API in a case where the predetermined program runs in the second operating environment, the second acquisition process being a process of acquiring an IP address assigned to an interface associated with the second OS, and perform a second transmission process in the second information processing apparatus, the second transmission process including transmitting the IP address acquired by the second acquisition process and the scan job to the communication apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a communication system.

FIGS. 2A and 2B are diagrams illustrating examples of a software configuration of an information processing apparatus.

FIG. 3 is a flowchart illustrating an apparatus search performed by a communication application.

FIG. 4 is a diagram illustrating an example of Extensible Markup Language (XML) data returned as a response result by a communication apparatus.

FIG. 5 is a flowchart illustrating a scanning function implemented by the communication application.

FIG. 6 is a diagram illustrating an example of a notification screen.

FIG. 7 is a flowchart illustrating a scanning function implemented by the communication application.

### DESCRIPTION OF THE EMBODIMENTS

Embodiments will be described in detail below with reference to the attached drawings. It should be noted that the following embodiments are not intended to limit the scope of the claimed disclosure. While a plurality of features is described in the embodiments, not all of the plurality of features are essential to the solution provided by the present disclosure, and the plurality of features may be combined in any combination. Further, in the attached drawings, identical or similar components are assigned the same reference numeral, and redundant descriptions thereof are omitted.

### First Embodiment

An information processing apparatus included in a communication system according to the present embodiment and a communication apparatus will be described. While a smartphone is used as an example of the information processing apparatus according to the present embodiment, this is not intended to be limiting, and various information processing apparatuses are applicable, such as a mobile terminal, a laptop personal computer (laptop PC), a tablet terminal, a personal digital assistant (PDA), and a digital camera. Further, various apparatuses capable of wirelessly communicating with the information processing apparatus are applicable as the communication apparatus. For example, a printer such as an inkjet printer, a full-color laser beam printer, or a monochrome printer is applicable as the communication apparatus. Further, a scanner, a copy machine, a facsimile apparatus, a mobile terminal, a smartphone, a laptop PC, a tablet terminal, a PDA, a digital camera, a music reproduction device, a television, a smart speaker, and the like, as well as a printer, are also applicable. Further, a multi-function peripheral including a plurality of functions, such as copy, fax, print, and scanner functions, is also applicable. According to the present embodiment, the communication apparatus is a multi-function printer including printing, scanner, and other functions.

### Hardware Configuration of Each Apparatus

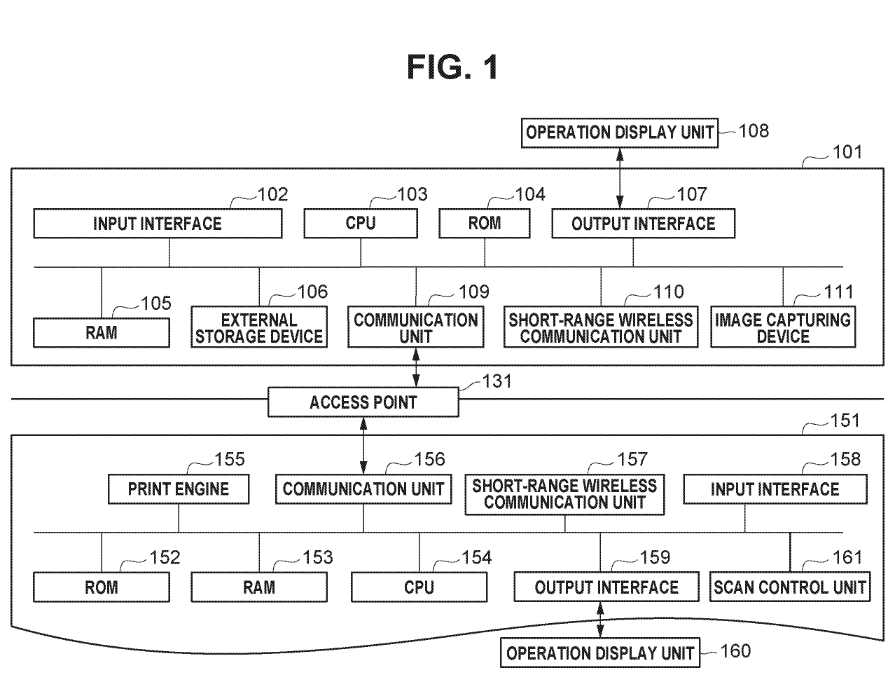

First, a configuration of the information processing apparatus included in the communication system according to the present embodiment and a configuration of the communication apparatus configured to communicate with the information processing apparatus will be described below with reference to a block diagram illustrated in FIG. 1. Further, while the following configurations are described as examples in the present embodiment, the functions are not particularly limited to those illustrated in FIG. 1.

An information processing apparatus 101 includes components such as an input interface 102, a central processing unit (CPU) 103, a read-only memory (ROM) 104, a random access memory (RAM) 105, an external storage device 106, an output interface 107, an operation display unit 108, a communication unit 109, a short-range wireless communication unit 110, and an image capturing device 111. The input interface 102 is an interface configured to receive data input and an operation instruction from a user, and includes components such as a physical keyboard, a display button, and a touch panel. It should be noted that the output interface 107, which will be described below, and the input interface 102 may be integrated into a single unit, and the single unit may be configured to perform screen output and receive an operation from the user.

The CPU 103 is a system control unit and controls the entire information processing apparatus 101. The ROM 104 stores fixed data, such as a control program configured to be executed by the CPU 103, a data table, and an embedded operating system (hereinafter, referred to as “embedded OS”) program. According to the present embodiment, each control program stored in the ROM 104 controls software execution, such as scheduling, task switching, and interruption processing, under the management of the embedded OS stored in the ROM 104. It should be noted that according to the present embodiment, an operating system (OS) stored in the ROM 104 and configured to run on the information processing apparatus 101 is either an Android® OS provided by Google Inc. or a Chrome® OS provided by Google Inc. In a case where the OS running on the information processing apparatus 101 is a Chrome OS, the ROM 104 also stores a virtual Android OS configured to run an Android OS application, which will be described below, on the information processing apparatus 101. It should be noted that the OS running on the information processing apparatus 101 is not limited to those described above and may be another OS other than Android® OS and Chrome® OS.

The RAM 105 includes a component requiring a backup power source, such as a static RAM (SRAM). It should be noted that the RAM 105 retains data using a primary battery for data backup, which is not illustrated, thereby making it possible to store important data, such as a program control variable, without losing the data. Further, the RAM 105 also includes a memory area to store information and data, such as setting information about the information processing apparatus 101 and management data of the information processing apparatus 101. Further, the RAM 105 is also used as a main memory and a work memory of the CPU 103.

The external storage device 106 includes an application program (hereinafter, referred to as “communication application”) including a function configured to communicate with a communication apparatus 151. It should be noted that the communication application is specifically, for example, an application including a print function configured to cause the communication apparatus 151 to perform printing and a scanning function configured to cause the communication apparatus 151 to perform scanning. It should be noted that the communication application is not limited to that described above and may be an application including one of the print function and the scanning function (an application for printing or an application for scanning) or may be an application including another function. For example, the communication application may be a setup application including a function configured to execute a network setup process to connect the communication apparatus 151 to an external access point. According to the present embodiment, the communication application includes the print function, the scanning function, and the function configured to execute the network setup process. The communication application further includes other functions such as a print job transmission function, a scan job transmission function, and a copy job transmission function, which will be described below. The external access point is, for example, an access point 131, which will be described below. Further, the external storage device 106 includes various programs, such as a printing information generation program and an information transmission and reception control program. The printing information generation program is configured to generate printing information interpretable by the communication apparatus 151, and the information transmission and reception control program is configured to transmit and receive information to and from the communication apparatus 151 connected via the communication unit 109. These programs may be included in the above-described applications or may be configured separately from the applications. Further, the external storage device 106 stores various types of information used by the programs. The external storage device 106 further stores image data acquired from another information processing apparatus or the Internet via the communication unit 109. It should be noted that according to the present embodiment, the communication application is an Android OS application.

The output interface 107 is an interface configured to perform control so that the operation display unit 108 displays data and a notification of a state of the information processing apparatus 101. The operation display unit 108 includes components, such as a light-emitting diode (LED) and a liquid crystal display (LCD), and is configured to display data and a notification of a state of the information processing apparatus 101. It should be noted that a software keyboard including keys, such as a numeric input key, a mode setting key, a determination key, a cancellation key, and a power key, may be provided on the operation display unit 108 to receive input from the user via the operation display unit 108.

The communication unit 109 is configured to connect to an apparatus, such as the communication apparatus 151, and perform data communication. For example, the communication unit 109 is configured to connect to an access point (not illustrated) in the communication apparatus 151. Establishing a connection between the communication unit 109 and the access point in the communication apparatus 151 enables communication between the information processing apparatus 101 and the communication apparatus 151. Hereinafter, the access point may also be referred to as the AP. It should be noted that the communication unit 109 may communicate with the communication apparatus 151 either directly via wireless communication or via the access point 131 external to both the information processing apparatus 101 and the communication apparatus 151. According to the present embodiment, an Institute of Electrical and Electronics Engineers (IEEE) 802.11 series communication standard is used as a wireless communication method. It should be noted that the IEEE 802.11 series communication standard refers to Wi-Fi®.

Further, the access point 131 is, for example, a device such as a wireless local area network (local LAN) router. It should be noted that according to the present embodiment, a method in which the information processing apparatus 101 and the communication apparatus 151 are directly connected without an external access point is referred to as a direct connection method. Further, a method in which the information processing apparatus 101 and the communication apparatus 151 are connected via the access point 131 external to the information processing apparatus 101 and the communication apparatus 151 is referred to as an infrastructure connection method.

The short-range wireless communication unit 110 is configured to establish a short-range wireless connection with an apparatus, such as the communication apparatus 151, and perform data communication with the apparatus. The short-range wireless communication unit 110 performs communication using a communication method different from that used by the communication unit 109. Examples of short-range wireless communication methods that may be used by the short-range wireless communication unit 110 include Bluetooth® and Near Field Communication (NFC). Bluetooth may be Bluetooth Classic or Bluetooth Low Energy. The short-range wireless communication unit 110 is configured to connect to a short-range wireless communication unit 157 included in the communication apparatus 151.

The image capturing device 111 is configured to convert an image captured by an image sensor into digital data. The digital data is first stored in the RAM 105. Then, the digital data is converted into a predetermined image format by a program executed by the CPU 103, and the converted data is stored as image data in the external storage device 106.

The communication apparatus 151 includes components such as a ROM 152, a RAM 153, a CPU 154, a print engine 155, a communication unit 156, the short-range wireless communication unit 157, an input interface 158, an output interface 159, an operation display unit 160, and a scan control unit 161. The communication apparatus 151 is configured to operate in a connection mode (communication mode) by setting the connection mode.

The communication unit 156 is configured to enable the communication apparatus 151 to communicate with another apparatus. According to the present embodiment, the communication unit 156 communicates using an IEEE 802.11 series communication standard. The communication unit 156 includes an access point configured to connect to an apparatus, such as the information processing apparatus 101, as the access point included in the communication apparatus 151. It should be noted that the access point is configured to connect to the communication unit 109 of the information processing apparatus 101. It should be noted that the communication unit 156 may communicate with the information processing apparatus 101 either directly via wireless communication or via the access point 131. Further, the communication unit 156 may include hardware configured to function as an access point, or may operate as an access point using software configured to cause the communication unit 156 to function as an access point. It should be noted that according to the present embodiment, the communication unit 156 and the short-range wireless communication unit 157 are realized by a single wireless chip. In other words, according to the present embodiment, an integrated chip is used that supports both a communication function based on an IEEE 802.11 series communication standard and a communication function using a short-range wireless communication method. However, this is not intended to be limiting, and the communication unit 156 and the short-range wireless communication unit 157 may be respectively realized by separate wireless chips.

The RAM 153 includes a component requiring a backup power source, such as a dynamic RAM (DRAM). It should be noted that the RAM 153 retains data using a backup power source, which is not illustrated, thereby making it possible to store important data, such as a program control variable, without losing the data. Further, the RAM 153 is also used as a main memory and a work memory of the CPU 154. The RAM 153 operates as a reception buffer to temporarily store printing information received from the information processing apparatus 101 or the like, and stores various types of information.

The ROM 152 stores fixed data, such as a control program configured to be executed by the CPU 154, a data table, and an OS program. According to the present embodiment, each control program stored in the ROM 152 controls software execution, such as scheduling, task switching, and interruption processing, under the management of an embedded OS stored in the ROM 152. Further, the ROM 152 also includes a memory area to store data that is required to be retained even when no power is supplied, such as setting information about the communication apparatus 151 and management data of the communication apparatus 151.

The CPU 154 is a system control unit and controls the entire communication apparatus 151. The print engine 155 forms an image on a recording medium, such as paper, using a recording agent, such as ink, based on information stored in the RAM 153 or a print job received from the information processing apparatus 101 or the like, and outputs the printing result. At this time, the print job transmitted from the information processing apparatus 101 or the like involves a large amount of transmission data and requires high-speed communication. Accordingly, the print job is received via the communication unit 156 configured to perform communication at a higher speed than the short-range wireless communication unit 157.

The short-range wireless communication unit 157 is configured to establish a short-range wireless connection with an apparatus, such as the information processing apparatus 101, and perform data communication with the apparatus. The short-range wireless communication unit 157 performs communication using a communication method different from that used by the communication unit 156. Examples of short-range wireless communication methods that may be used by the short-range wireless communication unit 157 include Bluetooth® and NFC. Bluetooth may be Bluetooth Classic or Bluetooth Low Energy. The short-range wireless communication unit 157 is configured to connect to the short-range wireless communication unit 110.

The input interface 158 is an interface configured to receive data input and an operation instruction from the user, and includes components such as a physical keyboard, a button, and a touch panel. It should be noted that the output interface 159, which will be described below, and the input interface 158 may be integrated into a single unit, and the single unit may be configured to perform screen output and receive an operation from the user. The output interface 159 is an interface configured to perform control so that the operation display unit 160 displays data and a notification of a state of the communication apparatus 151.

The operation display unit 160 includes components, such as a light-emitting diode (LED) and a liquid crystal display (LCD), and is configured to display data and a notification of a state of the communication apparatus 151. It should be noted that a software keyboard including keys, such as a numeric input key, a mode setting key, a determination key, a cancellation key, and a power key, may be provided on the operation display unit 160 to receive input from the user via the operation display unit 160.

The scan control unit 161 includes an image sensor unit (reading unit) configured to scan an original document placed on a platen glass or an automatic document feeder (ADF), which are not illustrated. It should be noted that the image sensor unit includes a light source configured to emit light to the original document and an image sensor in which elements configured to read reflected emitted light and photoelectrically convert the read light are arrayed. The scan control unit 161 performs analog/digital (A/D) conversion on an analog electric signal acquired by the image sensor unit by reading the original document, thereby acquiring image data. The scan control unit 161 includes a circuit configured to perform a direct memory access (DMA) transfer to store the acquired image data in the RAM 153.

### Direct Connection Method

A direct connection refers to a type of connection in which a wireless connection is established directly (i.e., peer-to-peer) between apparatuses without an external apparatus, such as the access point 131. The communication apparatus 151 is configured to operate in a mode (direct connection mode) in which communication is performed via a direct connection, as one of connection modes. In Wi-Fi communication, a plurality of modes exists in which communication is performed via a direct connection, such as a software AP mode and a Wi-Fi Direct® mode. Hereinafter, Wi-Fi Direct will be referred to as WFD.

A mode in which a direct connection is established using WFD is referred to as a WFD mode. WFD is a specification established by the Wi-Fi Alliance and included in the IEEE 802.11 series communication standards. In the WFD mode, after a device that serves as a communication partner is discovered based on device search information, roles of a peer-to-peer (P2P) group owner (GO) and a P2P client are determined, and then the remaining wireless connection process is performed. The group owner corresponds to a Wi-Fi master station (master station), and the client corresponds to a Wi-Fi slave station (slave station).

The role determination corresponds to, for example, a P2P GO negotiation. It should be noted that in the WFD mode before the role determination is performed, the communication apparatus 151 is neither a master station nor a slave station. Specifically, first, one of devices configured to communicate with each other issues device search information and searches for another device to connect to in the WFD mode. Upon discovering the other device that serves as a communication partner, the devices confirm information about services and functions that can be provided by each device. It should be noted that the confirmation of device provision information is optional and is not required. This phase for confirming device provision information corresponds to, for example, P2P provision discovery. Next, the devices confirm the device provision information about each other to determine which device serves the role of a P2P client and which device serves the role of a P2P group owner. Next, after the client and the group owner are determined, the devices exchange parameters to communicate using WFD. The P2P client and the group owner perform the remaining wireless connection process and an Internet Protocol (IP) connection process based on the exchanged parameters. It should be noted that in the WFD mode, the communication apparatus 151 may be configured to operate as a GO without performing the above-described GO negotiation. In other words, the communication apparatus 151 may operate in the WFD mode, which is an autonomous GO mode. Further, a state where the communication apparatus 151 operates in the WFD mode refers to, for example, a state where no WFD connection is established but the communication apparatus 151 operates as a GO, or a state where a WFD connection is established and the communication apparatus 151 operates as a GO.

In the software AP mode, one (for example, the information processing apparatus 101) of communicating devices (for example, the information processing apparatus 101 and the communication apparatus 151) operates as a client to serve the role of requesting various services. Further, the other device realizes a Wi-Fi access point function through a software setting. A software AP corresponds to a Wi-Fi master station, and the client corresponds to a Wi-Fi slave station. In the software AP mode, the client searches for a device that serves as a software AP based on device search information. Once a software AP is discovered, the client and the software AP perform the remaining wireless connection process (such as establishing a wireless connection) and thereafter perform an IP connection process (such as assigning an IP address). It should be noted that a command and a parameter transmitted and received between the client and the software AP to establish a wireless connection may be those defined in the Wi-Fi specification, and descriptions thereof are omitted herein.

According to the present embodiment, in a case where a direct connection is established and maintained by the communication apparatus 151, the communication apparatus 151 operates as a master station within a network to which the communication apparatus 151 belongs. It should be noted that the master station refers to a device configured to establish a wireless network and provide a slave station with a parameter used to connect to the wireless network. The parameter used to connect to the wireless network refers to, for example, a parameter relating to a channel used by the master station. The slave station receives the parameter, thereby connecting to the wireless network established by the master station using the channel used by the master station. In the direct connection mode, since the communication apparatus 151 operates as the master station, the communication apparatus 151 can determine a frequency band and channel to be used for communication in the direct connection mode. According to the present embodiment, the communication apparatus 151 allows channels corresponding to the 2.4 GHz and 5 GHz frequency bands to be used for communication in the direct connection mode. Further, the frequency band to be used (in other words, the frequency band corresponding to the channel to be used) is configurable by the user via a corresponding setting on a screen displayed by the communication apparatus 151. It should be noted that according to the present embodiment, even in a case where 5 GHz is selected on the screen displayed by the communication apparatus 151, the communication apparatus 151 does not use a channel corresponding to a Dynamic Frequency Selection (DFS) band within the 5 GHz frequency band for communication in the direct connection mode. In other words, the communication apparatus 151 uses only a channel corresponding to a frequency band other than a DFS band within the 5 GHz frequency band for communication in the direct connection mode. It should be noted that in a case where a channel corresponding to a DFS band is in use and a radar signal in a frequency band corresponding to the channel is detected, it is required to change the currently used channel. Such a frequency band in which a channel change may occur in response to detection of a radar signal is referred to as a DFS band. It should be noted that in a case where, for example, a wireless chip configured to support a DFS function is used, a channel corresponding to a DFS band within the 5 GHz frequency band may be used for communication in the direct connection mode.

### Infrastructure Connection Method

An infrastructure connection refers to a type of connection in which a connection is established with an access point (for example, the access point 131) configured to manage a network of devices configured to communicate with each other (for example, the information processing apparatus 101 and the communication apparatus 151) and the devices communicate via the access point. The communication apparatus 151 is further configured to operate in a mode (infrastructure connection mode) in which communication is performed via an infrastructure connection, as one of the connection modes.

In the infrastructure connection, each device searches for an access point based on device search information. Once an access point is discovered, the device and the access point perform the remaining wireless connection process (such as establishing a wireless connection) and thereafter perform an IP connection process (such as assigning an IP address). It should be noted that a command and a parameter transmitted and received between the device and the access point to establish a wireless connection may be those defined in the Wi-Fi specification, and descriptions thereof are omitted herein.

According to the present embodiment, when the communication apparatus 151 operates in the infrastructure connection mode, the access point 131 operates as a master station, and the communication apparatus 151 operates as a slave station. In other words, according to the present embodiment, the infrastructure connection refers to a connection between the communication apparatus 151 operating as a slave station and the apparatus operating as a master station. In a case where an infrastructure connection is established by the communication apparatus 151 and another infrastructure connection is established between the information processing apparatus 101 and the access point 131, the communication apparatus 151 and the information processing apparatus 101 can communicate with each other via the access point 131. A channel to be used for communication in the infrastructure connection is determined by the access point 131, and the communication apparatus 151 performs communication in the infrastructure connection using the channel determined by the access point 131. According to the present embodiment, the communication apparatus 151 is configured to use a channel corresponding to the 2.4 GHz frequency band and a channel corresponding to the 5 GHz frequency band for communication in the infrastructure connection. It should be noted that the communication apparatus 151 is further configured to use a channel corresponding to a DFS band within the 5 GHz frequency band for communication in the infrastructure connection. It should be noted that in order to communicate with the communication apparatus 151 via the access point 131, the information processing apparatus 101 is required to recognize that the communication apparatus 151 belongs to a network that is formed by the access point 131 and to which the information processing apparatus 101 belongs. Further, in a case where the information processing apparatus 101 and the communication apparatus 151 are connected to the access point 131 in the infrastructure connection, the information processing apparatus 101 may discover the communication apparatus 151 by broadcasting.

### Network Setup Mode

The communication apparatus 151 is configured to operate in a network setup mode. A trigger for causing the communication apparatus 151 to start operating in the network setup mode may be, for example, a press of a network setup mode button by the user or initial activation (initial power-on) of the communication apparatus 151 after delivery. The network setup mode button may be a hardware (physical) button of the communication apparatus 151 or a software button displayed on the operation display unit 160 of the communication apparatus 151.

Upon starting operation in the network setup mode, the communication apparatus 151 enables Wi-Fi communication. Specifically, as a Wi-Fi communication enabling process, the communication apparatus 151 enables an AP (connection setting AP) dedicated to the network setup mode and included in the communication apparatus 151. Consequently, the communication apparatus 151 enters a state where the communication apparatus 151 can establish a Wi-Fi direct connection with the information processing apparatus 101. Connection information for establishing a connection with the connection setting AP is stored in advance in the communication application installed in the information processing apparatus 101, and the information processing apparatus 101 recognizes the connection information for establishing a connection with the connection setting AP in advance. Thus, unlike connection information for an AP enabled in the direct connection mode, the connection information for establishing a connection with the connection setting AP cannot be freely changed by the user. It should be noted that the connection information includes a service set identifier (SSID) and a password. Further, in the network setup mode, the communication apparatus 151 may establish a connection with the information processing apparatus 101 using Wi-Fi Direct (WFD) instead of standard Wi-Fi. In other words, the communication apparatus 151 may operate as a group owner and receive a setting command from the information processing apparatus 101 via Wi-Fi Direct communication. Further, in the network setup mode, the communication apparatus 151 may establish a Bluetooth connection with the information processing apparatus 101. Bluetooth herein includes Bluetooth Classic and Bluetooth Low Energy (BLE). In other words, for example, in the network setup mode, the communication apparatus 151 may operate as a slave device in Bluetooth Low Energy and receive a setting command from the information processing apparatus 101 via Bluetooth Low Energy communication. Further, in the network setup mode, the communication apparatus 151 may be configured to execute both Wi-Fi and Bluetooth Low Energy network setups. In other words, the communication apparatus 151 may enable both Wi-Fi and Bluetooth Low Energy communications upon starting operation in the network setup mode. Specifically, upon starting operation in the network setup mode, the communication apparatus 151 may enable both the connection setting AP and an advertising state, which is a state where a Bluetooth Low Energy connection can be established by transmitting advertisement information using Bluetooth Low Energy.

When operating in the network setup mode, the communication apparatus 151 controls the communication unit 156 and operates as a network setup access point, which is enabled only during operation in the network setup mode. In other words, the network setup access point is a connection setting AP. The setup access point is an access point different from an access point that is enabled during the software AP mode. Further, an SSID of the setup access point includes a predetermined character string from which the communication application of the information processing apparatus 101 can be identified.

Further, the communication apparatus 151 operating in the network setup mode uses a predetermined communication protocol (communication protocol for setup) for communication with the information processing apparatus 101 connected to the setup access point. Specifically, the communication protocol for setup is, for example, the Simple Network Management Protocol (SNMP).

After a predetermined time from the start of operation in the network setup mode, the communication apparatus 151 stops operating in the network setup mode and disables the setup access point. Further, the communication apparatus 151 disables the setup access point also in a case where connection information for establishing a connection with the access point 131 and an instruction to change the operation mode for wireless communication are received from the information processing apparatus 101 during the network setup mode. Further, the setup access point is an access point that does not require a password for connection. It should be noted that the setup access point may be an access point that requires a password. In this case, the password used to establish a connection with the setup access point is a fixed password that is stored in advance in the communication application (and cannot be changed by the user).

Hereinafter, a type of connection in which the information processing apparatus 101 and the communication apparatus 151 are directly connected without the access point 131 may be referred to as a direct connection. Further, a type of connection in which the information processing apparatus 101 and the communication apparatus 151 are each connected to an external access point may be referred to as an infrastructure connection.

### Software Configuration of the Information Processing Apparatus 101

Next, software configurations of the information processing apparatus 101 according to the present embodiment will be described.

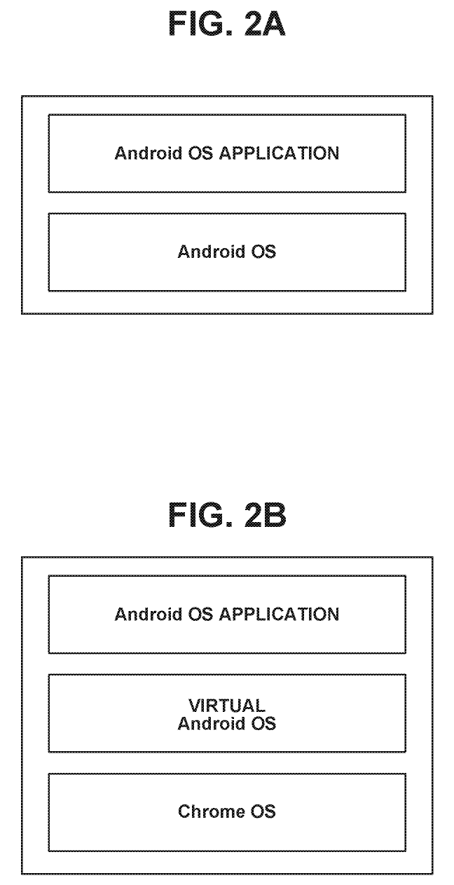

FIG. 2A illustrates an example of a software configuration of the information processing apparatus 101 for a case where a host OS running on the information processing apparatus 101 is an Android OS (first OS). In the present embodiment, an Android OS application runs on the Android OS. In the present embodiment, the software configuration of the information processing apparatus 101 does not include a Chrome OS. Hereinafter, an environment in which the OS running on the lowermost layer of the information processing apparatus 101 is an Android OS (not a Chrome OS) as in the present embodiment will be referred to as a first environment (first operating environment). The first environment specifically refers to, for example, an environment in which the information processing apparatus 101 includes a host OS but does not include a guest OS and an application runs on the host OS. Further, the first environment specifically refers to, for example, an environment in which the information processing apparatus 101 includes both a host OS and a guest OS and an application configured to run according to the present embodiment runs on the host OS without using the guest OS (the application does not run on the guest OS). It should be noted that the host OS refers to a host operating system, and the guest OS refers to a guest operating system.

FIG. 2B illustrates an example of a software configuration of the information processing apparatus 101 for a case where the host OS running on the information processing apparatus 101 is a Chrome OS (second OS). In the present embodiment, a virtual Android OS, which is a virtual OS, runs on the Chrome OS. Further, the Android OS application runs on the virtual Android OS. Hereinafter, an environment in which the OS that runs on the lowermost layer of the information processing apparatus 101 is the Chrome OS and the virtual Android OS runs on the Chrome OS, as in the present embodiment, will be referred to as a second environment (second operating environment). It should be noted that according to the present embodiment, the virtual OS refers to a program configured to enable an application that does not support the host OS to run on the host OS, and is the guest OS. It should be noted that virtual OS may be the entire existing OS, such as Android OS, the entire existing OS excluding some modules, or a program created separately from the existing OS. Further, the virtual OS is realized by a virtualization technology, such as a virtual machine method or a container method. It should be noted that the information processing apparatus 101 that includes the first environment and the information processing apparatus 101 that includes the second environment are different information processing apparatuses 101. In other words, a process that is performed in a case where the communication application runs in the first environment, which will be described below, is performed by a first information processing apparatus 101 including the first environment. On the other hand, a process that is performed in a case where the communication application runs in the second environment, which will be described below, is performed by a second information processing apparatus 101 including the second environment. However, on a single information processing apparatus 101, a state where the first environment is established and a state where the second environment is established may be switched by, for example, installing or uninstalling the host OS and/or the guest OS on the single information processing apparatus 101. In other words, both the process that is performed in a case where the communication application runs in the first environment and the process that is performed in a case where the communication application runs in the second environment may be performed on the single information processing apparatus 101 based on the environment established on the single information processing apparatus 101. It should be noted that while a configuration in which the host OS is the Chrome OS or the Android OS and the guest OS is the virtual Android OS is described in the present embodiment, the configuration is not intended to be limiting. The host OS may be another OS different from the Chrome OS or the Android OS, and the guest OS may be another OS different from the virtual Android OS.

The Android OS application will be described. It should be noted that the communication application will be described as an example of the Android OS application. Further, an example of a case where the communication application is installed and executed in each of the first environment and the second environment will be described. It should be noted that an application for printing configured to provide a function that communicates with the communication apparatus 151 including a print function and causes the communication apparatus 151 to print data, such as a document or an image, will be described as an example of the communication application. Further, an application developed in accordance with Android OS for execution on Android OS may be referred to as an Android application.

In a case where the Android OS application runs in the second environment, the following issue may occur.

According to the present embodiment, the communication application includes a function (scanning function) that transmits a scan job to cause the communication apparatus 151 to perform a scan and acquires image data (scan data) obtained from the scan performed based on the scan job from the communication apparatus 151. Further, according to the present embodiment, the communication application acquires an IP address of the information processing apparatus 101 and transmits a scan job including the acquired IP address to the communication apparatus 151. However, in a case where the communication application runs in the second environment, acquiring the IP address using a method similar to the method used in a case where the communication application runs in the first environment may lead to an issue that the communication application may not be able to acquire scan data obtained by the communication apparatus 151. Details of the issue will be described.

The communication application activates a Web-based Distributed Authoring and Versioning (WebDAV) server and a File Transfer Protocol (FTP) server within the information processing apparatus 101 to transmit a scan job to the communication apparatus 151 configured to perform a push scan. Then, the communication application instructs the OS to transmit the scan job.

The communication apparatus 151 herein is an apparatus configured to perform a push scan. In a case where the scan job is received by the communication apparatus 151 configured to perform a push scan, a communication session between the information processing apparatus 101 and the communication apparatus 151 is temporarily disconnected. Thus, in order for the communication apparatus 151 to transmit scan data to the information processing apparatus 101, the communication apparatus 151 is required to re-establish the communication session between the information processing apparatus 101 and the communication apparatus 151.

In order to re-establish the session, the communication apparatus 151 is required to designate an IP address specifying a transmission destination of the scan data.

Thus, according to the present embodiment, the communication application stores the IP address of the information processing apparatus 101 in the scan job transmitted to the communication apparatus 151. Then, the communication apparatus 151 refers to the received scan job, thereby identifying the IP address specifying the transmission destination of the scan data.

In a case where the communication application runs in the first environment, the communication application acquires the address of the information processing apparatus 101 as a transmission source address using a first application programming interface (first API) provided by the Android OS. The first API refers to an application programming interface (API) configured to enable the application to acquire an IP address assigned to a network interface associated with the Android OS and is specifically an API invoked by the program code “getConnectionInfo().getIpAddress()”. Then, in a case where the communication application runs in the first environment, the communication application transmits the IP address acquired by the first API to the communication apparatus 151, and the communication apparatus 151 identifies the IP address, whereby the session is successfully re-established.

On the other hand, in a case where the communication application runs in the second environment, the virtual Android OS assigns an IP address to a virtual interface configured as a network interface used by the WebDAV server and the FTP server. Hereinafter, the IP address assigned to the virtual interface associated with the virtual Android OS will be referred to as a first address. Further, an IP address assigned to an interface associated with the Chrome OS, rather than the virtual interface, will be referred to as a second address. Then, in a case where the communication application executes the first API in the second environment, the first address is acquired, rather than the second address, by the communication application.

Since the first address is a private IP address within the information processing apparatus 101, the communication apparatus 151 cannot establish a new session using the first address. As a result, in the second environment, an issue may arise where the communication application may not be able to acquire scan data obtained from the scan performed by the communication apparatus 151 based on the scan job configured to cause the communication apparatus 151 to perform a push scan.

However, in a case where a session is established using the second address instead of the first address, the communication apparatus 151 can transmit data to the information processing apparatus 101.

Thus, according to the present embodiment, the communication application acquires the second address using a method different from the method that uses the first API, in the second environment. Specifically, in the second environment, the communication application acquires the second address by invoking a second application programming interface (second API) different from the first API. The second API is an API configured to acquire the second address and is an API invoked by the program code “new ProcessBuilder().command” and an API invoked by the program code “readInput()”. Specifically, the communication application invokes the API using the program code “new ProcessBuilder().command” and the argument “”/system/bin/getprop”, ”vendor.arc.net.ipv4.host_address””, thereby instructing the virtual Android OS to acquire the second address. In response to the instruction, the virtual Android OS instructs the Chrome OS to acquire the second address. Then, the virtual Android OS acquires the IP address acquired by the Chrome OS based on the instruction. Thereafter, the communication application invokes the API using the program code “readInput()”, thereby acquiring the second address acquired by the virtual Android OS from the Chrome OS. Using the foregoing method enables the communication application to acquire the second address, which is the IP address used to establish a session between the communication apparatus 151 and the information processing apparatus 101, also in the second environment. Thereafter, the communication application transmits a scan job including the second address acquired by invoking the second API to the communication apparatus 151.

Upon receiving the scan job, the communication apparatus 151 establishes a communication session with the information processing apparatus 101 using the second address, thereby successfully establishing the session. This enables the communication application to acquire scan data obtained from a scan performed by the communication apparatus 151 based on the scan job configured to cause the communication apparatus 151 to perform a push scan.

### Apparatus Search Performed by the Communication Application

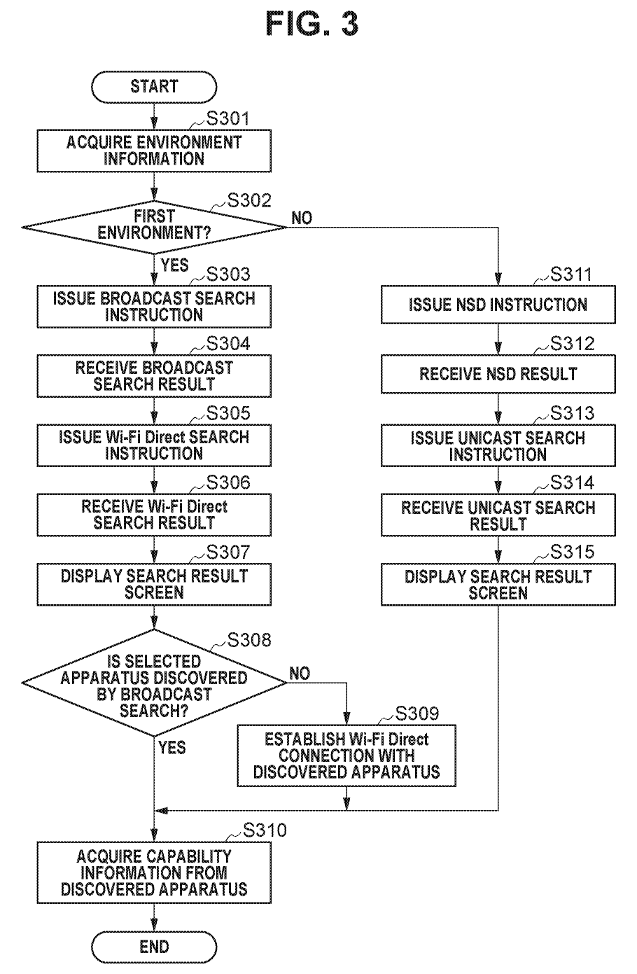

FIG. 3 is a flowchart illustrating an apparatus search performed by the communication application according to the present embodiment. It should be noted that the flowchart is realized by the CPU 103 by reading various programs stored in a memory, such as the external storage device 106, into the RAM 105 and executing the programs. Specifically, the flowchart is realized by executing the communication application. Further, the process is started in a case where an operation that triggers an apparatus search is performed by the user on a screen displayed by the communication application. It should be noted that this is not intended to be limiting, and the process may be started in a case where, for example, the communication application is activated.

In step S301, the CPU 103 executes the API provided by the Android OS using the communication application, thereby acquiring environment information about the environment in which the communication application operates. In a case where the environment in which the communication application operates is the first environment, information corresponding to the first environment is acquired as environment information. On the other hand, in a case where the environment in which the communication application operates is the second environment, the executed API is an API provided by the virtual Android OS, and information corresponding to the second environment is acquired as environment information.

In step S302, the CPU 103 determines whether the environment in which the communication application operates is the first environment, based on the environment information acquired in step S301. In a case where the determination result is YES (YES in step S302), the processing proceeds to step S303. In a case where the determination result is NO (NO in step S302), the processing proceeds to step S311.

In step S303, the CPU 103 determines the content of a broadcast search packet using the communication application. Then, the CPU 103 executes a socket API using the communication application, thereby instructing the Android OS to transmit the packet with the determined content using the communication application. In other words, the CPU 103 performs a broadcast search process using the communication application. By performing the process, the CPU 103 causes the Android OS to transmit the broadcast search packet to the access point 131. Further, according to the present embodiment, the broadcast search packet is configured so that only an apparatus that supports the communication application can respond to the packet. Further, according to the present embodiment, a plurality of types of broadcast search packets is broadcast. Specifically, the plurality of types of broadcast search packets includes a packet type configured so that only an inkjet printer can respond and a packet type configured so that only an electrophotographic printer can respond. It should be noted that a packet type configured so that only an inkjet printer of an earlier model can respond and/or a packet type configured so that only an inkjet printer of a newer model can respond may be included. Specifically, for example, the CPU 103 performs control to change a search target apparatus by changing a port number in a broadcast search packet. This enables discovery of only a desired apparatus using a broadcast search. Furthermore, it is also possible to determine the type of the apparatus discovered by the broadcast search (e.g., whether the discovered apparatus is an inkjet or electrophotographic printer).

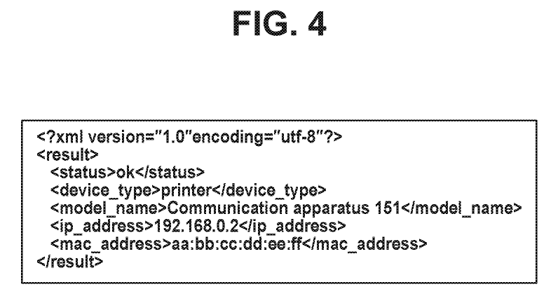

In step S304, the CPU 103 acquires a response to the broadcast search packet from the Android OS using the communication application. As a result, the transmission source apparatus of the response is identified as the apparatus discovered by the broadcast search. FIG. 4 illustrates an example of Extensible Markup Language (XML) data returned as a response result to the broadcast search by the communication apparatus 151. A status tag represents a response result to an inquiry. In this example, the status tag indicates a successful inquiry. Further, device_type and model_name tags respectively represent an apparatus type and an apparatus model name. The information processing apparatus 101 is configured to recognize an apparatus associated with a device_type tag in which information as a printer is stored as a printer. Thus, in the example, the tags indicate that the apparatus model of the communication apparatus is printer and the apparatus model name is “Communication apparatus 151”. Further, an ip_address tag represents an IP address of the communication apparatus. In the example, the tag indicates that the IP address of the communication apparatus is 192.168.0.2. Further, a mac_address tag represents a Media Access Control (MAC) address of the communication apparatus and indicates that the MAC address is aa:bb:cc:dd:ee:ff. It should be noted that information described in data returned as a response result by the communication apparatus and a data format are not limited to those described above, and various types of information about the communication apparatus may be described.

While a configuration in which a process for a broadcast search is performed in steps S303 and S304 has been described above, a configuration in which a process for a multicast search is performed in steps S303 and S304 may also be employed. In other words, in step S303, the CPU 103 may determine the content of a multicast search packet using the communication application and execute the socket API using the communication application, thereby instructing the Android OS to transmit the packet with the determined content using the communication application. Then, in step S304, the CPU 103 may acquire a response to the multicast search packet from the Android OS using the communication application.

In step S305, the CPU 103 executes a Wi-Fi Direct API, thereby instructing the Android OS to perform a Wi-Fi Direct search (i.e., transmit device search information using Wi-Fi Direct) using the communication application. Consequently, the CPU 103 causes the Android OS to transmit device search information. Thereafter, the Android OS receives a device search response from an apparatus located near the information processing apparatus 101 and configured to support Wi-Fi Direct.

In step S306, the CPU 103 acquires the device search response from the Android OS using the communication application. Consequently, the transmission source apparatus of the device search response is identified as an apparatus discovered by the Wi-Fi Direct search. It should be noted that at that time, only the transmission source apparatus of the device search response that supports a printing service may be identified as an apparatus discovered by the Wi-Fi Direct search. It is possible to identify a service supported by each apparatus via communication between the transmission source apparatus of the device search response and the information processing apparatus 101.

In step S307, the CPU 103 displays a search result screen based on the information acquired in steps S304 and S306 using the communication application. The search result screen is a screen configured to display a list that includes one or more apparatuses discovered by the broadcast search and one or more apparatuses discovered by the Wi-Fi Direct search. It should be noted that the search result screen may display the list so that it is possible to distinguish between the one or more apparatuses discovered by the broadcast search and the one or more apparatuses discovered by the Wi-Fi Direct search. Specifically, for example, an icon corresponding to an apparatus discovered by the broadcast search may be added to each display item corresponding to an apparatus discovered by the broadcast search on the search result screen. Further, similarly, an icon corresponding to an apparatus discovered by the Wi-Fi Direct search may be added to each display item corresponding to an apparatus discovered by the Wi-Fi Direct apparatus on the search result screen. Further, the search result screen may display the list so that it is possible to distinguish between inkjet and electrophotographic printers. Then, the CPU 103 receives a selection of an apparatus displayed on the search result screen from the user using the communication application.

In step S308, the CPU 103 determines whether the selected apparatus is an apparatus discovered by the broadcast search. In a case where the determination result is YES (YES in step S308), the processing proceeds to step S310. In a case where the determination result is NO (NO in step S308), the processing proceeds to step S309.

In step S309, the CPU 103 instructs the Android OS to establish a Wi-Fi Direct connection between the selected apparatus and the information processing apparatus 101 using the communication application. Consequently, the Android OS performs a process of establishing a Wi-Fi Direct connection between the selected apparatus and the information processing apparatus 101. It should be noted that according to the present embodiment, the information processing apparatus 101 is capable of maintaining a Wi-Fi Direct connection and a standard Wi-Fi connection in parallel. Thus, the CPU 103 herein establishes a Wi-Fi Direct connection between the selected apparatus and the information processing apparatus 101 while maintaining a Wi-Fi connection between the access point 131 and the information processing apparatus 101.

In step S310, the CPU 103 acquires capability information from the selected apparatus. Specifically, the capability information includes information indicating whether the apparatus supports a print function and/or a scanning function, information indicating whether the supports duplex printing and/or color/monochrome printing, information indicating types of a recording agent and a recording medium supported by the apparatus, and other information. It should be noted that the capability information may include identification information about the apparatus, such as the MAC address, apparatus model name, and IP address. The communication application manages the selected apparatus in association with the capability information, thereby registering the selected apparatus in the communication application. Thereafter, it becomes possible for the communication application to transmit various jobs to the apparatus registered in the communication application.

It also becomes possible for the communication application to cause the apparatus registered in the communication application to perform processes corresponding to the various jobs. Thereafter, the process illustrated in the flowchart ends.

On the other hand, in a case where the determination result is NO in step S302, in step S311, the CPU 103 performs a process using the communication application to search for an apparatus located on the network to which the information processing apparatus 101 belongs, using an API different from the socket API. Specifically, the API used herein is a network service discovery (NSD) API. Upon execution of the API by the communication application, a search referred to as NSD is performed. The NSD is a multicast search performed using a Domain Name System (DNS)-based service discovery protocol. Further, the NSD is a search that can be performed also in the second environment based on an instruction from the communication application. Specifically, upon execution of the API by the communication application in the process, the virtual Android OS instructs the Chrome OS to perform NSD. Then, the Chrome OS performs NSD, thereby discovering an apparatus that supports NSD and is located on the network to which the information processing apparatus 101 belongs. It should be noted that the communication application can specify a service during execution of the NSD API so that NSD is performed to discover an apparatus that supports the specified service. It should be noted that a service is specified by, for example, specifying a protocol. Thus, according to the present embodiment, the communication application specifies the Internet Printing Protocol (IPP), thereby specifying that an apparatus that supports the printing service (i.e., printer) is to be discovered. It should be noted that while the communication application specifies an IP address in a search instruction using the socket API to specify an apparatus that is a packet transmission destination, the communication application does not specify an IP address in a search instruction using the NSD API.

Next, in step S312, the CPU 103 acquires information about a discovered apparatus, as a result of the NSD search, using the communication application. Specifically, the acquired information includes, for example, an IP address and port number of the discovered apparatus and a service name.

Next, in step S313, the CPU 103 performs a unicast search process on one or more apparatuses discovered by NSD. It should be noted that while the unicast search process is performed on all apparatuses discovered by NSD in the present embodiment, this is not intended to be limiting. The unicast search process may be performed on some of the apparatuses discovered by NSD. The unicast search refers to a method of searching for a search target apparatus on the network to which the information processing apparatus 101 belongs by specifying an IP address of the search target apparatus. Since the IP address of each apparatus discovered by NSD is acquired as an NSD search result by the communication application, the apparatus discovered by NSD may be rediscovered by performing a unicast search. It should be noted that a broadcast search targets apparatuses within a subnetwork to which the information processing apparatus 101 belongs. On the other hand, a unicast search targets not only apparatuses within the subnetwork to which the information processing apparatus 101 belongs but also apparatuses within another subnetwork connected to the subnetwork. It should be noted that the subnetwork refers to a unit of a single network configured by a single access point. It should be noted that a unicast search may be performed also in the second environment based on an instruction from the communication application. Specifically, in the process, the CPU 103 determines the content of a unicast search packet using the communication application. Then, the CPU 103 executes the socket API, thereby instructing the virtual Android OS to transmit the packet with the determined content using the communication application. It should be noted that in the unicast search packet, a value used for a unicast search and specifying a packet transmission destination (i.e., a destination corresponding to the search target apparatus) is set in an area where the IP address is stored. Further, according to the present embodiment, the unicast search packet is configured so that only an apparatus that supports the communication application can respond to the packet. Further, according to the present embodiment, a plurality of types of unicast search packets is transmitted to a single apparatus. Specifically, the plurality of types of unicast search packets includes a packet type configured so that only an inkjet printer can respond and a packet type configured so that only an electrophotographic printer can respond. It should be noted that a packet type configured so that only an inkjet printer of an earlier model can respond and/or a packet type configured so that only an inkjet printer of a newer model can respond may be included. This enables discovery of only a desired apparatus using a unicast search. Furthermore, it is also possible to determine the type of the apparatus discovered by the unicast search (e.g., whether the discovered apparatus is an inkjet or electrophotographic printer). According to the present embodiment, the only difference between the content of the unicast search packet and the content of the broadcast search packet is the IP address specifying the packet transmission destination. Thereafter, the virtual Android OS instructs the Chrome OS to perform a unicast search. Then, the Chrome OS transmits the unicast search packet, thereby performing a unicast search. As a result, a response is received from an apparatus that is located on the network to which the information processing apparatus 101 belongs, and corresponds to the IP address specified in the unicast search packet, and the apparatus is discovered.

Next, in step S314, the CPU 103 acquires information about the discovered apparatus, as a result of the unicast search, using the communication application. Specifically, the acquired information includes, for example, an IP address, MAC address, model name (apparatus model name), and serial number of the discovered apparatus. Performing the unicast search following NSD enables identification of the apparatus discovered by NSD and supporting the communication application. Further, information that cannot be acquired by NSD can be acquired.

Next, in step S315, the CPU 103 displays a search result screen configured to display a list of apparatuses discovered by the unicast search using the communication application. It should be noted that the search result screen may display the list so that inkjet and electrophotographic printers can be distinguished. Then, the CPU 103 receives a selection of an apparatus displayed on the search result screen from the user using the communication application. Thereafter, the processing proceeds to step S310, and the CPU 103 registers the selected apparatus.

As described above, according to the present embodiment, whether a broadcast search is performed is determined based on the environment in which the communication application operates. Specifically, in a case where the environment in which the communication application operates is the first environment, a broadcast search is performed, and in a case where the environment in which the communication application operates is the second environment, another process is performed without performing a broadcast search. Specifically, for example, an NSD search or a unicast search is performed as the other process. This enables the communication application to perform an appropriate process based on the environment in which the communication application operates.

It should be noted that the communication application determines which one of broadcast, multicast, and unicast search instructions is to be issued based on the content of an address specified as an IP address that is specified during execution of the socket API and included in the packet transmitted for the search. Thus, in other words, the present embodiment is an embodiment in which the content of an IP address specified in a packet used for a search is changed based on the environment in which the communication application operates.

It should be noted that the process that is performed in a case where the environment in which the communication application operates is the second environment is not limited to the above-described configuration. For example, the process may be a process of displaying a notification screen configured to notify the user that it is not possible to perform a broadcast search. Further, in the configuration in which the notification screen is displayed, NSD and unicast searches may be omitted. Further, the notification screen may be, for example, a screen configured to notify the user that the environment in which the communication application operates is the second environment, or a screen configured to notify the user that a communication apparatus cannot be registered in the communication application. Further, the notification screen may be a screen configured to prompt the user to cause the communication application to operate in the first environment.

Further, the search method is not limited to the above-described method. For example, the process for a broadcast search (step S303, step S304) and the process for a Wi-Fi Direct search (step S305, step S306) may be performed in reverse order or in parallel. Further, each time an apparatus is discovered by either search, the discovered apparatus may be added to the search result screen, instead of displaying the search result screen after each search ends.

Further, the communication application may be configured to receive an operation to issue a broadcast search instruction and an operation to issue a Wi-Fi Direct search instruction separately from the user. Then, in a case where an operation to issue a broadcast search instruction is performed, the flowchart in FIG. 3 may be performed without performing the process for a Wi-Fi Direct search. Further, similarly, in a case where an operation to issue a Wi-Fi Direct search instruction is performed, the flowchart in FIG. 3 may be performed without performing the process for a broadcast search. Further, the communication application may be an application configured to support only one of broadcast and Wi-Fi Direct searches. In other words, in a case where the communication application supports only a broadcast search, the flowchart in FIG. 3 may be performed without performing the process for a Wi-Fi Direct search. Similarly, in a case where the communication application supports only a Wi-Fi Direct search, the flowchart in FIG. 3 may be performed without performing the process for a broadcast search.

Further, while a configuration in which the process for a unicast search (step S313, step S314) is performed after the process for NSD (step S311, step S312) is described above, the configuration is not intended to be limiting. For example, the process for a unicast search may be omitted in the flowchart in FIG. 3, and the search result screen may display an apparatus discovered by NSD. It should be noted that at that time, an apparatus that supports the communication application may store, as a response to NSD, information indicating that the apparatus supports the communication application. Consequently, only the apparatus identified as an apparatus that supports the communication application, among apparatuses discovered by NSD, may be displayed on the search result screen.

### Execution of the Scanning Function by the Communication Application

In a case where the communication apparatus 151 is registered in the communication application as described above, the communication application can transmit a scan job to the registered communication apparatus 151.

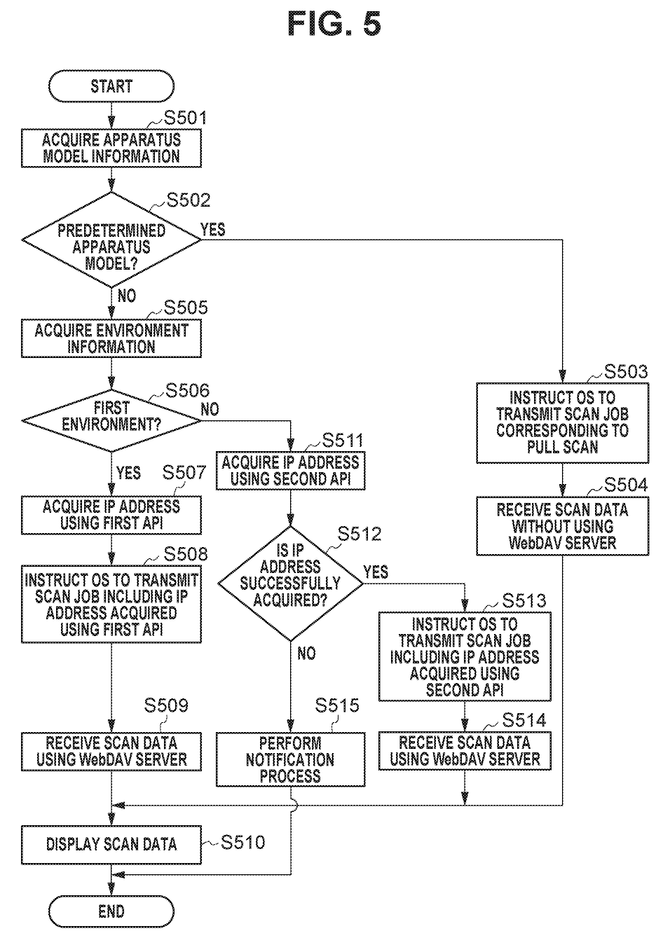

FIG. 5 is a flowchart illustrating the scanning function implemented by the communication application according to the present embodiment. It should be noted that the flowchart is realized by the CPU 103 by reading various programs stored in a memory, such as the external storage device 106, into the RAM 105 and executing the programs. Specifically, the flowchart is realized by executing the communication application. Further, the process is started in a case where an operation that triggers execution of the scanning function is performed by the user on a screen displayed by the communication application.

In step S501, the CPU 103 identifies an apparatus that is a scan job transmission destination, and acquires apparatus model information about the identified apparatus. Specifically, for example, the CPU 103 identifies the communication apparatus 151 registered in the communication application as a scan job transmission destination. In a case where a plurality of apparatuses is registered in the communication application, the CPU 103 may prompt the user to select an apparatus from the plurality of apparatuses registered in the communication application and may identify the selected apparatus as a scan job transmission destination. A user selection may be received in step S501 or may be received before the user performs an operation that triggers execution of the scanning function. In a case where the communication apparatus 151 is identified, the CPU 103 refers to capability information about the communication apparatus 151 managed for registration of the communication apparatus 151 in the communication application, thereby acquiring apparatus model information included in the capability information.

In step S502, the CPU 103 determines whether the apparatus model of the apparatus that is the scan job transmission destination is a predetermined apparatus model that supports a pull scan. The pull scan is a type of scanning in which scan data is received from the communication apparatus 151 via a session between the information processing apparatus 101 and the communication apparatus 151 established by the information processing apparatus 101. Further, the pull scan is a type of scanning in which scan data is received from the communication apparatus 151 without using the WebDAV server or the FTP server activated by the information processing apparatus 101. According to the present embodiment, for example, the predetermined apparatus model corresponds to an apparatus model that supports an inkjet printer configured to perform printing using an inkjet method or an apparatus model that supports an electrophotographic printer configured to perform printing using an electrophotographic method. Further, an apparatus model that supports an electrophotographic printer configured to perform printing using an electrophotographic method corresponds to an apparatus model that is different from the predetermined apparatus model and supports a push scan. In a case where the determination result is YES (YES in step S502), the processing proceeds to step S503. In a case where the determination result is NO (NO in step S502), the processing proceeds to step S505.

In step S503, the CPU 103 instructs an underlying OS of the communication application to transmit a scan job using the communication application. As a result, the scan job is transmitted from the information processing apparatus 101 to the communication apparatus 151. The underlying OS of the communication application is the Android OS in the first environment or the virtual Android OS in the second environment. In the second environment, the virtual Android OS further instructs the Chrome OS to transmit a scan job. It should be noted that the scan job transmitted herein is a job that causes the communication apparatus 151 to perform a pull scan and is generated by the communication application. The process transmits a scan job to the communication apparatus 151. It should be noted that the information processing apparatus 101 does not activate the WebDAV server or the FTP server in a case where a job for performing a pull scan is transmitted. Thereafter, the communication apparatus 151 performs a pull scan. Specifically, the communication apparatus 151 performs a pull scan based on the received scan job and acquires scan data. Thereafter, the communication apparatus 151 transmits the scan data to the information processing apparatus 101 via a session between the information processing apparatus 101 and the communication apparatus 151 established by the information processing apparatus 101. At that time, the communication apparatus 151 transmits the scan data to the information processing apparatus 101 without using the WebDAV server or the FTP server included in the information processing apparatus 101. It should be noted that in a case where step S503 is performed, unlike a case where step S503 is not performed (a case where the process from step S505 onward is performed), the process in which the communication application acquires an IP address by invoking the API is not performed. As a result, an IP address acquired by the communication application by invoking the API is not transmitted to the communication apparatus 151. It should be noted that the OS may automatically store an IP address in the header of the scan job. Thus, an IP address that is not an IP address acquired by the communication application by invoking the API may be transmitted to the communication apparatus 151 in the case where step S503 is performed.

In step S504, the CPU 103 acquires the scan data received from the communication apparatus 151 from the underlying OS of the communication application using the communication application without using the WebDAV server or the FTP server. Then, the processing proceeds to step S510.

In step S505, which is performed in a case where the determination result is NO in step S502, the CPU 103 acquires environment information. This process is similar to step S301.

In step S506, the CPU 103 determines whether the environment in which the communication application operates is the first environment, based on the environment information acquired in step S505. In a case where the determination result is YES (YES in step S506), the processing proceeds to step S507. In a case where the determination result is NO (NO in step S506), the processing proceeds to step S511. It should be noted that according to the present embodiment, as illustrated in FIG. 3, a different search process is performed based on the environment in which the communication application operates. Thus, the environment in which the communication application operates is identified based on the search process by which the apparatus serving as the transmission destination of the scan job is discovered. Thus, for example, the process of step S506 may be a process of identifying the search process by which the apparatus serving as the transmission destination of the scan job is discovered. Then, in a case where the identified search process is the search process that is performed in a case where the environment in which the communication application operates is the first environment, the processing may proceed to step S507. On the other hand, in a case where the identified search process is the search process that is performed in a case where the environment in which the communication application operates is the second environment, the processing may proceed to step S511.

In step S507, the CPU 103 invokes the first API, thereby acquiring the IP address assigned to the network interface associated with the Android OS.

In step S508, the CPU 103 instructs the Android OS to transmit a scan job including the IP address acquired in step S507 using the communication application. It should be noted that according to the present embodiment, the communication apparatus 151 refers to a job ticket included within a packet constituting the scan job to acquire the IP address used to transmit scan data acquired from a scan. Thus, according to the present embodiment, the IP address acquired in step S507 is stored in the job ticket within the packet constituting the scan job. Consequently, the scan job is transmitted from the information processing apparatus 101 to the communication apparatus 151. It should be noted that the scan job transmitted herein is a job that causes the communication apparatus 151 to perform a push scan and is generated by the communication application. Thus, the CPU 103 activates the WebDAV server using the communication application. Upon receiving the scan job and the IP address, the communication apparatus 151 performs a scan based on the scan job, establishes a session based on the IP address, and transmits scan data acquired from the scan to the information processing apparatus 101. It should be noted that while a configuration in which the IP address acquired in step S507 is included in the scan job and transmitted to the communication apparatus 151 is described above, this is not intended to be limiting. The IP address acquired in step S507 may be transmitted as data separate from the scan job to the communication apparatus 151.

In step S509, the CPU 103 acquires the scan data transmitted from the communication apparatus 151 using the WebDAV server from the Android OS using the communication application. It should be noted that while a configuration in which the WebDAV server is activated and used is described above, the FTP server may be activated and used instead of the WebDAV server.

In step S510, the CPU 103 displays an image represented by the scan data acquired using the communication application in step S504, S509, or S514. Thereafter, the process illustrated in the flowchart ends.

In step S511, which is performed in a case where the determination result is NO in step S506, the CPU 103 invokes the second API, thereby acquiring the second address.

In step S512, the CPU 103 determines whether the second address is successfully acquired using the second API. In a case where the determination result is YES (YES in step S512), the processing proceeds to step S513. In a case where the determination result is NO (NO in step S512), the processing proceeds to step S515. The determination is a process that is performed because the second API may fail to acquire the second address due to an operational state of the communication apparatus 151, a version of the communication application, or the like. Specifically, for example, in a case where the information processing apparatus 101 is connected to an access point enabled by the communication apparatus 151 operating in the software AP mode and the version of the communication application is equal to or earlier than a predetermined version, the second API may fail to acquire the second address.

In step S513, the CPU 103 instructs the Android OS to transmit a scan job including the IP address acquired in step S511 using the communication application. It should be noted that the IP address acquired in step S511 is stored in the job ticket within the packet constituting the scan job. Consequently, the scan job is transmitted from the information processing apparatus 101 to the communication apparatus 151. It should be noted that the scan job transmitted herein is a job that causes the communication apparatus 151 to perform a push scan and is generated by the communication application. Thus, the CPU 103 activates the WebDAV server using the communication application. Upon receiving the scan job and the IP address, the communication apparatus 151 performs a scan based on the scan job, establishes a session based on the IP address, and transmits scan data acquired from the scan to the information processing apparatus 101. It should be noted that while a configuration in which the IP address acquired in step S511 is included in the scan job and transmitted to the communication apparatus 151 is described above, this is not intended to be limiting. The IP address acquired in step S511 may be transmitted as data separate from the scan job to the communication apparatus 151.

In step S514, the CPU 103 acquires the scan data transmitted from the communication apparatus 151 using the WebDAV server from the virtual Android OS using the communication application.

Thereafter, the processing proceeds to step S510. It should be noted that while a configuration in which the WebDAV server is activated and used is described above, the FTP server may be activated and used instead of the WebDAV server.

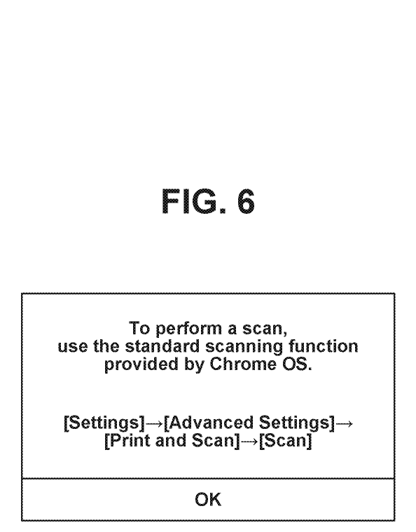

In step S515, which is performed in a case where the determination result is NO in step S512, the CPU 103 performs a notification process, which is a process of displaying a notification screen to provide a notification indicating that the scanning function cannot be executed from the communication application. FIG. 6 illustrates an example of a notification screen displayed in step S515. For example, the notification screen may be a screen configured to prompt the user to execute a standard scanning function included as standard in the host OS. Further, the notification screen may be a screen configured to present an operation for executing the standard scanning function. The notification screen may be a screen including a button for displaying a web manual using a web browser to present an operation for executing the scanning function included as standard in the host OS. It should be noted that the standard scanning function is executed by an application that is included as standard together with the host OS in the information processing apparatus 101 and executed by a standard scanning application configured to manage the standard scanning function. Thus, for example, the screen configured to prompt the user to execute the standard scanning function may also be referred to as a screen configured to prompt the user to use the standard scanning application. Further, for example, the screen configured to present an operation for executing the standard scanning function may also be referred to as a screen configured to present an operation for activating the standard scanning application. It should be noted that the notification screen may be, for example, a screen configured to prompt the user to confirm whether to activate the standard scanning application. Then, in a case where an input to activate the standard scanning function is received, the CPU 103 may activate the standard scanning application using the communication application. It should be noted that the standard scanning application is an application for the host OS and, therefore, operates without using the guest OS. Thus, the standard scanning application can acquire, from the communication apparatus 151, the scan data acquired from the scan performed based on the scan job transmitted and executed based on an instruction from the standard scanning application. Further, in step S515, the CPU 103 may perform an activation process to activate the standard scanning application using the communication application without performing the notification process. Further, in step S515, the CPU 103 may determine whether a version of the host OS supports the activation process, and the CPU 103 may perform the activation process in a case where the determination result is YES, or the CPU 103 may perform the notification process in a case where the determination result is NO. It should be noted that as the activated standard scanning application is operated by the user, the scan job is transmitted from the information processing apparatus 101 to the communication apparatus 151 or the like based on an instruction from the standard scanning application. It should be noted that the scan job transmitted based on the instruction from the standard scanning application is a job generated by the standard scanning application. Thus, the process of step S515 may also be referred to as a process of transmitting a scan job generated by the standard scanning application different from the communication application. After step S515, the process in the flowchart ends.

As described above, according to the present embodiment, the scan job is not transmitted to the communication apparatus 151 in a case where the environment in which the communication application operates is the second environment and the communication application cannot acquire the scan data from the communication apparatus 151. Then, for example, the process of displaying the notification screen or activating the standard scanning application is performed as a process that is not the scan job transmission process. This makes it possible to present an alternative method for acquiring the scan data to the user in a situation where the communication application cannot acquire the scan data from the communication apparatus 151.

It should be noted that the above-described issue that may occur in the second environment may also occur in a case where the host OS in the second environment is another OS other than the Chrome OS or a case where the guest OS in the second environment is another OS other than the Android OS. In other words, while the second environment in which the virtual Android OS runs on the Chrome OS and the Android OS application runs on the virtual Android OS is described above, this is not intended to be limiting. For example, the OS that runs on the lowermost layer may be another OS, such as Windows® OS provided by Microsoft Corporation or Mac® OS provided by Apple Inc., rather than the Chrome OS. Further, the guest OS and the application that runs on the guest OS may be iOS® and an iOS application, rather than Android OS and the Android OS application. Thus, for example, the CPU 103 may identify which OS runs as the host OS in the second environment using the communication application prior to step S515. Then, in the notification process performed in step S515, the notification screen with content corresponding to the identified OS may be displayed. Specifically, for example, in a case where the name of the standard scanning application and the method for activating the standard scanning application differ for each OS type, the notification screen may display a name of the standard scanning application corresponding to the identified OS and/or a method for activating the standard scanning application on the identified OS. Further, for example, in step S515, a process of activating the standard scanning application corresponding to the identified OS may be performed instead of the notification process.

### Second Embodiment

As described above, the host OS in the second environment is not limited to the Chrome OS and may be another OS, such as Windows OS. Further, for example, another application may exist that is for another OS provided by the same vendor as the communication application and is different from the communication application. In the present embodiment, a configuration in which different processes are performed depending on the type of the host OS in the second environment will be described.

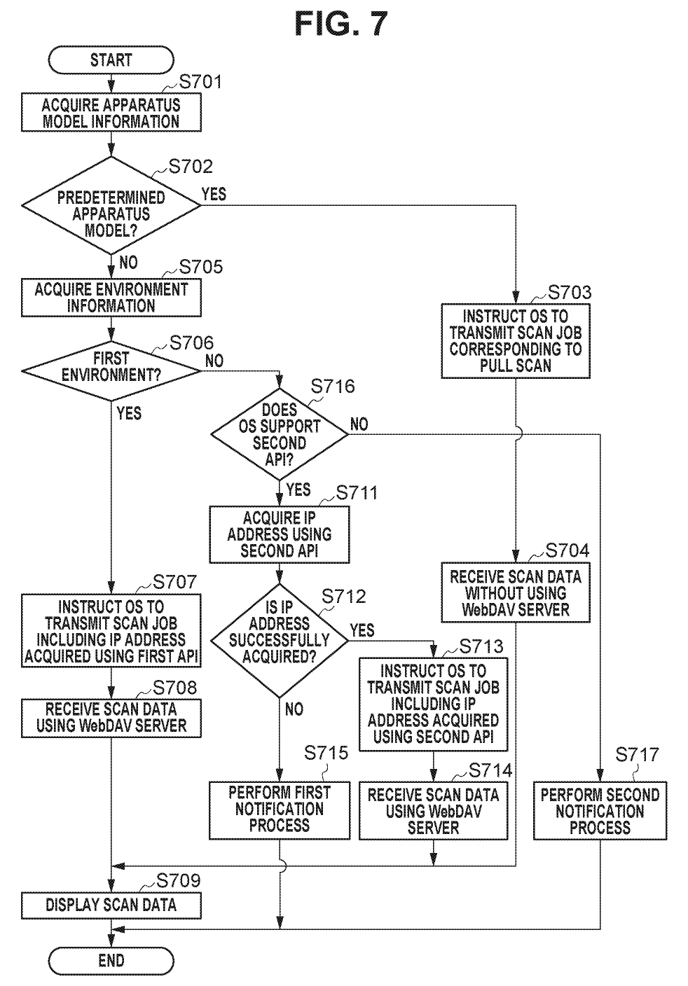

FIG. 7 is a flowchart illustrating the scanning function implemented by the communication application according to the present embodiment. It should be noted that the flowchart is realized by the CPU 103 by reading various programs stored in a memory, such as the external storage device 106, into the RAM 105 and executing the programs. Specifically, the flowchart is realized by executing the communication application. Further, the process is started in a case where an operation that triggers execution of the scanning function is performed by the user on a screen displayed by the communication application.

Steps S701 to S715 are similar to steps S501 to S515, so that redundant descriptions thereof are omitted.

In step S716, which is performed in a case where the determination result is NO in step S706, the CPU 103 identifies the host OS in the second environment using the communication application. Then, the CPU 103 determines whether the identified host OS supports the second API using the communication application. The determination process of step S716 may be a process of determining whether the host OS is a Chrome OS. In a case where the determination result is YES (YES in step S716), the processing proceeds to step S711. Further, in step S715, a notification process similar to that of step S515 is performed as a first notification process. On the other hand, in a case where the determination result is NO (NO in step S716), the processing proceeds to step S717. In a case where the host OS is a Windows OS, the determination result is NO.

In step S712, the CPU 103 performs a second notification process, which is a process of displaying a notification screen to prompt the user to use a specific scanning application. The specific scanning application is an application that is different from the communication application and is provided by the same vendor as the communication application. According to the present embodiment, the Chrome OS does not support the specific scanning application. Further, the Windows OS supports the specific scanning application. In other words, a scanning application for Windows OS exists as the specific scanning application. The scanning application for Windows OS is configured to operate without using the guest OS even in the second environment and acquire scan data acquired from a push scan performed by the communication apparatus 151. The notification screen displayed in step S712 may be, for example, a screen configured to display a button for activating the specific scanning application. It should be noted that in a case where the button is pressed and the specific scanning application is preinstalled on the information processing apparatus 101, the CPU 103 activates the specific scanning application. On the other hand, in a case where the button is pressed and the specific scanning application is not installed on the information processing apparatus 101, the CPU 103 activates a store application for installing the specific scanning application. The notification screen displayed herein may be, for example, a screen configured to prompt the user to confirm whether to activate the specific scanning application. Then, in a case where an input to activate the specific scanning application is received, the CPU 103 may activate the specific scanning application from the communication application. It should be noted that in step S717, the CPU 103 may activate the specific scanning application without performing the notification process. Thereafter, the process ends.

The foregoing configuration enables execution of an appropriate process for the type of the host OS in the second environment.

It should be noted that in the above-described configuration, the second notification process is performed in a case where the host OS is a Windows OS. However, this is not intended to be limiting, and in a case where the host OS is a Windows OS, a third API may be invoked by the communication application. The third API is an API that is configured to acquire an IP address assigned to a network interface associated with the Windows OS and is different from the first and second APIs. Then, a scan job including an IP address acquired by the third API may be transmitted to the communication apparatus 151.

### Other Embodiments

As described above, the Chrome OS may control a firewall so that a broadcast or multicast search that is based on an instruction from the Android OS application and uses the socket API is not executed. However, the firewall may fail to block the broadcast or multicast search depending on the content of the port number designated during execution of the socket API and set in the packet used for the search. Thus, for example, the communication application may instruct the virtual Android OS also in the second environment to perform a broadcast or multicast search that is not blocked by the firewall, using the socket API. Specifically, for example, a specific port number is specified in a packet type configured so that only an inkjet printer of an earlier model can respond, and a broadcast or multicast search using the packet is not blocked by the firewall. In this case, for example, in step S311, the CPU 103 may instruct the virtual Android OS to perform not only a search using the NSD API but also a broadcast search using the socket API and performed by transmitting a packet type configured so that only an inkjet printer of an earlier model can respond, using the communication application. Then, in step S315, the CPU 103 may display not only the search result of step S314 but also the result of the broadcast search performed based on the instruction. It should be noted that at this time, an apparatus discovered by both NSD and broadcast searches is controlled to prevent duplicate display of the apparatus. Consequently, for example, an apparatus of an apparatus model that cannot be discovered by an NSD search because the apparatus does not support the IPP or because of other reasons also becomes discoverable in the second environment.

Further, for example, the flowchart in FIG. 3 may be started in a case where the information processing apparatus 101 performs a network setting process on the communication apparatus 151 using the communication application. Specifically, for example, the network setting process is a process of transmitting information about the access point 131 to the communication apparatus 151 via a Wi-Fi or Bluetooth connection between the information processing apparatus 101 and the communication apparatus 151. Consequently, the communication apparatus 151 establishes a connection with the access point 131 using the information. Thereafter, in a case where the information processing apparatus 101 is also connected to the access point 131, the information processing apparatus 101 discovers the communication apparatus 151 as a result of performing the flowchart in FIG. 3. Thus, in a case where the information processing apparatus 101 transmits information about the access point 131 to the communication apparatus 151 via a Wi-Fi connection between the information processing apparatus 101 and the communication apparatus 151, the connection may be disconnected after the information is transmitted. Thereafter, a connection may be established between the information processing apparatus 101 and the access point 131. Further, for example, the flowchart started in a case where the network setting process is performed may be configured so that the search result screen is not displayed. Specifically, for example, a process of identifying an apparatus that is discovered by a search and on which the network setting process is performed may be performed, instead of the process of displaying the search result screen and receiving a selection from the user. Specifically, the identification process is performed by comparing a MAC address and a serial number that are information acquired from the communication apparatus 151 via the connection used for the network setting process and are information about the communication apparatus 151 on which the network setting process is performed and a MAC address and a serial number that are information about the apparatus discovered by the search. Then, capability information may be acquired from the apparatus identified as described above. Further, for example, the flowchart started in a case where the network setting process is performed may be configured so that the Wi-Fi Direct search process (such as step S305, step S306, step S308, and step S309) is not performed.

Further, a configuration in which an apparatus discovered by the NSD search in step S312 is determined as a target of the unicast search without user selection is described above. However, this is not intended to be limiting, and an apparatus discovered by the NSD search may be selected as a target of the unicast search based on a user selection, and the unicast search may be performed to discover only the determined apparatus. In this configuration, for example, the CPU 103 displays the search result screen configured to present a list of apparatuses discovered by the NSD search using the communication application after the NSD search is performed in step S312 and before the unicast search is performed. Then, the CPU 103 determines only an apparatus selected by the user from the apparatuses displayed on the search result screen as a target of the unicast search. Then, the CPU 103 instructs the virtual Android OS to transmit a unicast search packet in which an IP address of the determined apparatus is specified, using the communication application. Thereafter, the CPU 103 performs a process of registering an apparatus discovered by the unicast search in the communication application.

Further, a configuration in which in the second environment, the unicast search is performed after the NSD search is performed is described above. However, this is not intended to be limiting. For example, in the second environment, the unicast search may be performed without performing the NSD search. In this configuration, for example, in a case where the determination result is NO in step S302, the CPU 103 does not perform steps S311 and S312.

Then, the CPU 103 displays a screen configured to receive an IP address input from the user using the communication application. Then, in step S313, the CPU 103 performs a process of performing a unicast search for one or more apparatuses corresponding to the IP address input by the user via the screen. Specifically, the CPU 103 sets the IP address input by the user via the screen in a unicast search packet. Then, the CPU 103 executes the socket API, thereby instructing the virtual Android OS to transmit the packet in which the IP address input by the user via the screen is set, using the communication application.

Further, in the second environment, whether the NSD search has failed may be determined after the NSD search process is performed by the communication application. It should be noted that, for example, the determination is performed by determining whether the communication application is notified that the NSD search has failed. Then, in a case where it is determined that the NSD search has failed, the CPU 103 may display the screen configured to receive an IP address input from the user, using the communication application. Then, the CPU 103 may perform a process of performing a unicast search for one or more apparatuses corresponding to the IP address input by the user via the screen. Consequently, even in a case where the NSD search has failed and an IP address required for the unicast search is not acquired by the NSD search, the unicast search can still be performed.

Further, while a configuration in which both broadcast and Wi-Fi Direct searches are performed in a case where the determination result is YES in step S302, this is not intended to be limiting. Only one of the broadcast and Wi-Fi Direct searches may be performed in a case where the determination result is YES in step S302. Specifically, for example, in a case where only the broadcast search is performed in a case where the determination result is YES in step S302, steps S305, S306, S308, and S309 in the flowchart in FIG. 3 are omitted. Further, specifically for example, in a case where only the Wi-Fi Direct search is performed in a case where the determination result is YES in step S302, steps S303, S304, and S308 in the flowchart in FIG. 3 are omitted, and step S309 is always performed after step S307. Further, while a configuration in which the process illustrated in the flowchart in FIG. 3 is performed as a communication apparatus search process and the process illustrated in the flowchart in FIGS. 5 or 7 is performed as a scanning process is described above, this is not intended to be limiting. For example, the process illustrated in the flowchart in FIG. 3 may be performed as a communication apparatus search process, and a publicly-known process different from the process illustrated in the flowchart in FIGS. 5 or 7 may be performed as a scanning process. Further, for example, the process illustrated in the flowchart in FIG. 3 may be performed as a communication apparatus search process, and the communication application may not include the scanning function and may not perform a scanning process. Further, for example, a publicly-known process different from the process illustrated in the flowchart in FIG. 3 may be performed as a communication apparatus search process, and the process illustrated in the flowchart in FIG. 5 or 7 may be performed as a scanning process.

It should be noted that while the NSD API is executed in step S311 in the process illustrated in the flowchart in FIG. 3 in the above-described configuration, this is not intended to be limiting. For example, the NSD API may be executed prior to the flowchart in FIG. 3, for example, during activation of the communication application. In this configuration, for example, the determination corresponding to step S302 is performed prior to the flowchart in FIG. 3.

Then, in a case where it is determined that the environment is the first environment, the search process is not performed at that time, whereas in a case where it is determined that the environment is not the first environment, the NSD API is executed as in step S311. Then, step S311 in the flowchart in FIG. 3 is omitted. In this configuration, the NSD result may be acquired prior to the flowchart in FIG. 3. It should be noted that the host OS may continue performing NSD, and each time there is a change in the NSD result, the communication application may acquire the NSD result. Then, in step S312, a new NSD result may be acquired, or a previously acquired NSD result may be referenced.

The object of the present disclosure is also achieved by supplying a recording medium in which program codes of software configured to realize the functions according to the above-described embodiments are recorded to a system or an apparatus and causing a computer (or a CPU or a microprocessor unit (MPU)) of the system or the apparatus to read and execute the program codes stored in the recording medium. In this case, the program codes read from the storage medium realize the functions according to the above-described embodiments, and the storage medium storing the program codes constitutes the present disclosure.

As the storage medium for supplying the program codes, for example, a flexible disk, a hardware disk, an optical disk, a magneto-optical disk, a compact disc ROM (CD-ROM), a compact disc recordable (CD-R), a magnetic tape, a non-volatile memory card, a ROM, a digital versatile disc (DVD), or the like may be used.

The present disclosure makes it possible to improve the usability of a program configured to run in an operating environment on an OS running as a host OS and on a guest OS.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-046911, filed March 21, 2025, which is hereby incorporated by reference herein in its entirety.

What is claimed is:

1. A non-transitory computer-readable storage medium storing a predetermined program configured to run on an operating system (OS),
wherein the predetermined program causes a processor of a first information processing apparatus including a first operating environment on a first OS running as a host OS and not operational on a guest OS to:
perform a first acquisition process in the first information processing apparatus by causing the predetermined program to invoke a first application programming interface (first API) in a case where the predetermined program runs in the first operating environment, the first acquisition process being a process of acquiring an Internet Protocol (IP) address assigned to an interface associated with the first OS; and
perform a first transmission process in the first information processing apparatus, the first transmission process including transmitting the IP address acquired by the first acquisition process and a scan job that causes a communication apparatus to perform a scan, and
wherein the predetermined program causes a processor of a second information processing apparatus including a second operating environment on a second OS running as the host OS and operational on the guest OS to:
perform a second acquisition process in the second information processing apparatus by causing the predetermined program to invoke a second API different from the first API in a case where the predetermined program runs in the second operating environment, the second acquisition process being a process of acquiring an IP address assigned to an interface associated with the second OS; and
perform a second transmission process in the second information processing apparatus, the second transmission process including transmitting the IP address acquired by the second acquisition process and the scan job to the communication apparatus.

2. The non-transitory computer-readable storage medium according to claim 1,
wherein in a case where the communication apparatus is an apparatus of a predetermined apparatus model, the predetermined program performs a third transmission process regardless of whether the predetermined program runs in the first operating environment or in the second operating environment, the third transmission process being including transmitting the scan job excluding the IP address acquired by the first acquisition process and the IP address acquired by the second acquisition process to the communication apparatus, and
wherein in a case where the communication apparatus is an apparatus other than predetermined apparatus model, the predetermined program is controlled to perform the first acquisition process or the second acquisition process depending on whether the predetermined program runs in the first operating environment or in the second operating environment.

3. The non-transitory computer-readable storage medium according to claim 2,
wherein the apparatus of the predetermined apparatus model supports a pull scan operation, and the apparatus other than the predetermined apparatus model supports a push scan,
wherein the scan job transmitted in the third transmission process causes the communication apparatus to perform a pull scan, and
wherein the scan job transmitted in the first transmission process or in the second transmission process causes the communication apparatus to perform a push scan.

4. The non-transitory computer-readable storage medium according to claim 2, wherein the apparatus of the predetermined apparatus model that supports a process of transmitting scan data acquired from a scan performed based on the scan job to the second information processing apparatus without a Web-based Distributed Authoring and Versioning (WebDAV) server and a File Transfer Protocol (FTP) server, and the apparatus other than the predetermined apparatus model supports a process of transmitting the scan data to the second information processing apparatus via the WebDAV server or the FTP server.

5. The non-transitory computer-readable storage medium according to claim 1, wherein the scan job transmits scan data acquired from a scan performed based on the scan job to the second information processing apparatus via a WebDAV server or the FTP server.

6. The non-transitory computer-readable storage medium according to claim 1, wherein the predetermined program displays scan data acquired from a scan performed based on the scan job by the communication apparatus and received from the communication apparatus.

7. The non-transitory computer-readable storage medium according to claim 1,
wherein the IP address acquired by the first acquisition process is included in the scan job transmitted by the first transmission process, and
wherein the IP address acquired by the second acquisition process is included in the scan job transmitted by the second transmission process.

8. The non-transitory computer-readable storage medium according to claim 7,
wherein execution of the predetermined program causes the processor of the second information processing apparatus to:
perform a first search process to search for an apparatus on a network to which the second information processing apparatus belongs in a case where the predetermined program runs in the second operating environment; and
register at least one apparatus discovered by the search performed by the second information processing apparatus in the predetermined program.

9. The non-transitory computer-readable storage medium according to claim 8, wherein the first process is a process of instructing the guest OS to perform the search using a network service discovery (NSD) application programming interface (API).

10. The non-transitory computer-readable storage medium according to claim 1, wherein the predetermined program performs a process of transmitting a print job to perform printing.

11. The non-transitory computer-readable storage medium according to claim 1,
wherein in the first operating environment, the first OS running as the host OS is an Android® OS, and the guest OS does not run on the host OS, and
wherein in the second operating environment, the second OS running as the host OS is a Chrome® OS, and the guest OS is a virtual Android® OS.

12. The non-transitory computer-readable storage medium according to claim 1, wherein the predetermined program is an application program for Android® OS.

13. The non-transitory computer-readable storage medium according to claim 1,
wherein execution of the predetermined program by the processor of the first information processing apparatus is further caused to perform a first determination process to determine whether the predetermined program runs in the first operating environment or in the second operating environment,
wherein execution of the predetermined program by the processor of the second information processing apparatus is further caused to perform a second determination process to determine whether the predetermined program runs in the first operating environment or in the second operating environment,
wherein in a case where it is determined that the predetermined program runs in the first operating environment, the first acquisition process is performed, and
wherein in a case where it is determined that the predetermined program runs in the second operating environment, the second acquisition process is performed.

14. The non-transitory computer-readable storage medium according to claim 1, wherein the first API is an API invoked by the program code getConnectionInfo().getIpAddress().

15. The non-transitory computer-readable storage medium according to claim 1, wherein the second API is an API invoked by the program code new ProcessBuilder().command and an API invoked by the program code readInput().

16. The non-transitory computer-readable storage medium according to claim 1,
wherein in a case where the predetermined program runs in the second operating environment and a type of the host OS is a first type, the second acquisition process is performed, and
wherein in a case where the predetermined program runs in the second operating environment and the type of the host OS is a second type different from the first type, a process related to a specific program different from the predetermined program is performed, the specific program being a program provided by the same vendor as the predetermined program.

17. The non-transitory computer-readable storage medium according to claim 16, wherein the process related to the specific program is at least one of a process of prompting a user to use the specific program, a process of prompting the user to confirm whether to activate the specific program, a process of installing the specific program on the second information processing apparatus, and a process of activating the specific program.

18. The non-transitory computer-readable storage medium according to claim 1, wherein the computer of the second information processing apparatus is further caused to perform a process related to another program different from the predetermined program in the second information processing apparatus in a case where the predetermined program fails to acquire the IP address assigned to the interface associated with the second OS although the second acquisition process is performed, the other program being configured to control a scanning function included as standard in the host OS.

19. The non-transitory computer-readable storage medium according to claim 18, wherein the process related to the other program is at least one of a process of prompting a user to use the other program, a process of presenting an operation for activating the other program, a process of prompting the user to confirm whether to activate the other program, and a process of activating the other program.

20. A method for controlling a first information processing apparatus including a predetermined program configured to run on an operating system (OS) and including a first operating environment on a first OS running as a host OS and not on a guest OS and a second information processing apparatus including the predetermined program and including a second operating environment on a second OS running as the host OS and on the guest OS, the method comprising:
performing a first acquisition process in the first information processing apparatus by causing the predetermined program to invoke a first application programming interface (first API) in a case where the predetermined program runs in the first operating environment, the first acquisition process being a process of acquiring an Internet Protocol (IP) address assigned to an interface associated with the first OS;
performing a first transmission process in the first information processing apparatus, the first transmission process including transmitting the IP address acquired by the first acquisition process and a scan job configured to cause a communication apparatus to perform a scan to the communication apparatus;
performing a second acquisition process in the second information processing apparatus by causing the predetermined program to invoke a second API different from the first API in a case where the predetermined program runs in the second operating environment, the second acquisition process being a process of acquiring an IP address assigned to an interface associated with the second OS; and
performing a second transmission process in the second information processing apparatus, the second transmission process including transmitting the IP address acquired by the second acquisition process and the scan job to the communication apparatus.
